(19) United States
(12) Patent Application Publication
(10) Pub. No.: US 2018/0209447 A1
(43) Pub. Date: Jul. 26, 2018

(54) Centrifugal Pump Blade Profile

(71) Applicant: KSB Aktiengesellschaft, Frankenthal (DE)

(72) Inventor: Peer SPRINGER, Frankenthal (DE)

(21) Appl. No.: 15/745,635

(22) PCT Filed: Jun. 23, 2016
(86) PCT No.: PCT/EP2016/064605

§ 371 Date: Jan. 17, 2018

(30) Foreign Application Priority Data
Jul. 17, 2015 (DE) 10 2015 213 451.2

(51) Int. Cl. F04D 29/66; F04D 29/22; F04D 29/24; F04D 7/04

(52) U.S. Cl. CPC F04D 29/666; F04D 29/225; F04D 29/245; F05D 2250/72; F04D 7/04; F05D 2240/301; F04D 29/2277

(57) ABSTRACT

A centrifugal pump with a rotor having at least one blade and a method for configuring the profile of a blade is provided. The blade has a profile which is obtained by superposing a symmetric profile with at least one additional profile and a camber line whose blade inlet angle is smaller than 0°.

### CROSS REFERENCE TO RELATED APPLICATIONS

This application is a continuation of PCT International Application No. PCT/EP2016/064605, filed Jun. 23, 2016, which claims priority under 35 U.S.C. § 119 from German Patent Application No. 10 2015 213 451.2, filed Jul. 17, 2015, the entire disclosures of which are herein expressly incorporated by reference.

### BACKGROUND AND SUMMARY OF THE INVENTION

The invention relates to a centrifugal pump having an impeller which has at least one blade and a method for configuring the profile of a blade of the impeller of a centrifugal pump.

The invention further relates to centrifugal pumps which are used to convey media containing solids. In this instance, channel type impellers, free-flow impellers or single blade impellers can be used as impellers. Ducted wheels are open or closed impellers with a reduced number of blades. One, two or three blades in radial and semi-axial impellers have been found to be advantageous. The fields of application thereof are liquids which are silted up or loaded with solid materials.

An important parameter for characterizing the usability of such pumps for conveying solid admixtures is the ball passage. The ball passage is also referred to as a free, unnarrowed impeller passage and describes the largest permissible diameter of the solid materials in order to ensure a blockage-free passage.

DE 40 15 331 A1 describes an impeller with only one blade. The single blade impeller produced using a casting method forms between a front cover plate and a rear cover plate a channel whose cross-section decreases from the intake of the single blade impeller toward the discharge. The intake side forms on the first 180° of the rotation angle a semi-circle which is arranged concentrically with respect to the rotation axis. The single blade impeller is constructed in such a manner that an occurrence of cavitations is reduced.

In contrast to single blade impellers, impellers with a plurality of blades are distinguished by a higher degree of efficiency. However, specific requirements are also placed on such impellers in terms of preventing deposits of solid components in the conveying channel. In impellers having multiple blades, specific measures have to be taken to prevent blockages.

DE 88 00 074 U1 describes a pump impeller for a centrifugal pump whose blade intake angle is between 0° and 40°. The impeller blades are constructed in this instance in such a manner that the occurrence of cavitations is reduced and nonetheless a good capacity for suction is ensured in the overload region. To this end, the flow lines of the impeller blades have a portion in which the blade angle increases up to 25°.

In waste water technology, centrifugal pumps with high specific speeds are increasingly used. With conventional impellers, this results, in the event of a blade being subjected to flow, in the stagnation point thereof, in particular during partial load operation, moving to the pressure side of the blades. The intake edges of the blades are flowed around from the pressure side to the intake side. The stagnation point located at the pressure side presses fibers located in the waste water onto the surface of the blades.

When the intake edges of the blades are flowed around, there is a region of high speed. In impellers whose intake edge has a smaller radius of curvature, the speeds are particularly high in this region. If, as a result of the high flow speed, the static pressure falls below the vapor pressure, vapor bubbles which lead to cavitation damage are formed.

The high speed region is adjoined by a region of low speed. Dead water is produced at that location. Fibers which adhere to the intake edge tend to fill this dead water region. As a result of the flow, the fibers are pressed onto the blade contour, wherein the occupation with fibers can increase considerably.

DE 10 2011 007 907 B3 relates to an impeller of a centrifugal pump for conveying media containing solid material. The impeller has at least two blades. The blade intake angle is in this instance less than 0°. The blade angle increases in a first portion until it reaches a value of 0°. In a second portion, there is a further increase until a maximum value is reached. In a third portion, the blade angle decreases again.

The ball passage, the steepness of the characteristic line, the cavitation properties and the blade loading have a particular relationship in waste water impellers. In contrast to applications for clean water, the ball passage is of central importance.

In addition, in impellers, cavitation freedom up to a practically provided NPSH value and smooth running of the wheels is also required. Both conditions can be complied with by a small blade loading (conveying height/blade surface) under the peripheral condition of a hydraulically impact-free design.

In applications for high speeds, steep characteristic lines are desired. This characteristic line shape is achieved with low blade numbers (1 or 2). In addition, the blades are intended to have a large wrap-around.

The characteristic line shape is determined by the staggering angle of the blades. The angles at the intake and discharge substantially determine the adaptation of the design to the desired operating location or change the load distribution (pressure difference between blade intake to blade pressure side) along the blade contour.

If small staggering angles or small, partially negative intake angles are combined with very small discharge angles, the loading of the blades as far as the most narrow cross-section which determines the ball passage is increased to a great extent. The larger the ball passage is, the smaller the staggering angle. The smaller the discharge angle is, the higher the loading up to the narrowest cross-section. The increased loading leads to increased NPSH values and in the most unfavorable case to flow separation and consequently to a loss of efficiency.

Consideration is given here to an impeller in which for the conveying of solid material large ball passages in combination with a steep characteristic line are required. The resulting small staggering angles combined with partially negative intake angles and very small intake angles produce an extreme loading of the blades as far as the narrowest cross-section which determines the ball passage. This loading leads to separation in the intake and return flow at the pressure side.

As a result, the object of the invention is to provide a centrifugal pump having an impeller in which the loading of the blades is minimized. In this instance, separation or cavitation regions are intended to be prevented. The formation of dead water regions or return flow regions is also intended to be prevented.

According to the invention, the blade has a profile which is produced by superimposing a symmetrical profile with at least one additional profile and a median line whose blade intake angle is less than 0°. Such a profile ensures uniform loading of the entire blade face. The loading or circulation in this instance is limited to the respective minimum magnitude. Separation or cavitation regions at the intake side are thereby prevented. At the pressure side, as a result of the profile according to the invention, dead water or return flow regions can be prevented in a selective manner.

The term median line (also profile center line or camber line or curvature line) is used to refer to the connection line of the circle center points which are inscribed in a profile. From the projection circle center point to the profile projection, the median line extends in a straight manner. The path of the median line substantially also determines the flow properties. Important geometric characteristic values of the median lines are, in addition to the blade angle, the angle of wrap.

The median line which is used for superimposition in this instance preferably has an angle path in which the negative blade intake angle initially increases until it reaches a value of 0. In a second portion, the blade angle then increases to a maximum value and finally decreases again in a third portion. In a preferred embodiment of the invention, the blade angle of the median line remains constant in an adjacent fourth portion.

As far as the narrowest cross-section, there is available a region which rises with a decreasing number of blades and in which the loading (circulation) can be configured in a variable manner. According to the invention, this load variation is carried out with additional profiles. According to the invention, the profiles are varied in each blade calculation step with regard to length and thickness separately at the intake and pressure side in order to reduce the loading and consequently to prevent at the intake side cavitation or separation and at the pressure side dead water or return flow.

In this instance, the desired profile is formed from a characteristic median line, a symmetrical basic profile and additional profiles at the intake side and additional profiles at the pressure side.

The symmetrical basic profile is preferably a profile of equal thickness with an elliptical profile projection.

The additional profiles can be provided on the basis of catalogue profiles. For example, NACA profiles (National Advisory Committee for Aeronautics) can for this purpose.

The superimposition is carried out in this instance in a planar mapping system of the Kaplan method.

The profile shapes according to the invention are produced by the superimposition of the characteristic median line which has a negative blade intake angle, together with a thickness distribution or a profile droplet. The completed profile is then positioned at the necessary angle of attack βₘ in a conformal mapping.

The entire blade is produced by conformal mapping of the individual blade portions which are present in the plane in the flood faces which are present as axially symmetrical rotation faces. Preferably, 1 to 3 flood faces, but a maximum of 7, are involved in this case.

By comparing the parameters which describe the droplets via the flow line radii, a sufficiently smooth surface is produced. The provision of the blade profile is preferably carried out by superimposing an asymmetrical profile droplet and the characteristic median line.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is an axial section through an impeller,

FIG. 2 are plan views of variable droplets on three flow lines,

FIG. 3 is a meridional section,

FIG. 4a shows a path of the blade angle,

FIG. 4b is a conformal mapping of the median line,

FIG. 5 shows a variable region for a thickness variation,

FIG. 6 shows a profile structure in conformal mapping prior to superimposition with the median line,

FIG. 7 shows a superimposition profile using the example of an NACA profile,

FIG. 8 is a conformal mapping of variable droplets on three flow lines,

FIG. 9 is a perspective illustration of an impeller according to an embodiment of the present invention.

### DETAILED DESCRIPTION OF THE DRAWINGS

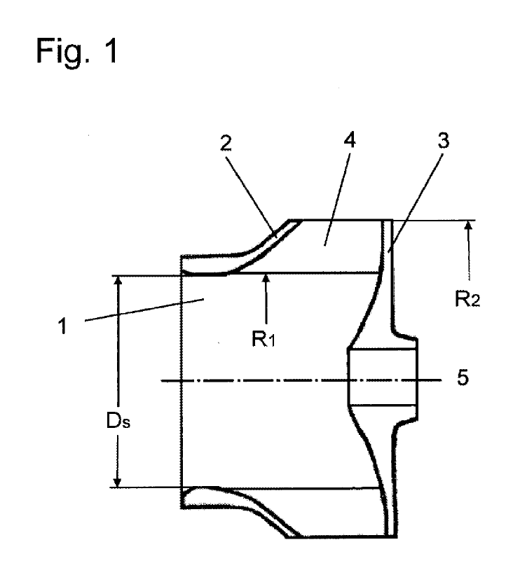

FIG. 1 is an axial section through a radial impeller. The liquid which is charged with solid admixtures enters the intake mouth 1 of the impeller. The blades 4 which are arranged between the covering plate 2 and carrier plate 3 accelerate the liquid. The liquid flows radially outward from the rotation axis 5.

The impeller is in particular operated at specific speeds of more than 70 l/min. In this instance, a low ratio of blade discharge radius R₂ to blade intake radius R₁ is found to be particularly favorable. In the embodiment, the ratio of blade discharge radius R₂ to blade intake radius R₁ is less than 1.3.

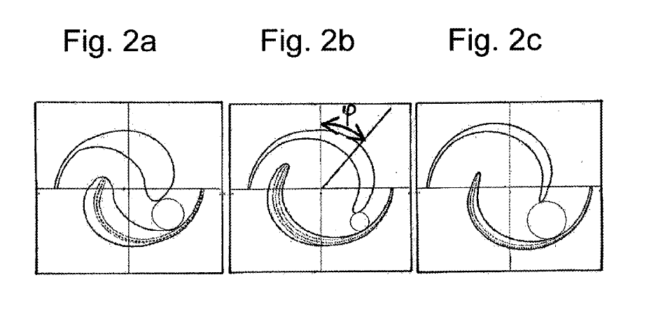

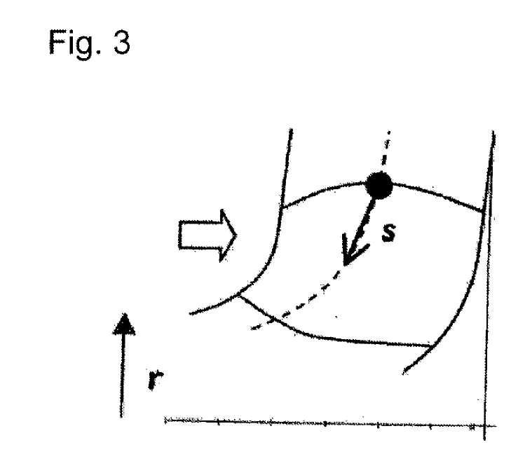

FIGS. 2a, 2b and 2c show variable droplets on three flow lines as a plan view. FIG. 3 shows the three flow lines as a meridional section. By comparing the parameters which describe the droplets over the flow line radius R, there is produced a sufficiently smooth surface. The additional profile droplets are highlighted. The basic profile is left.

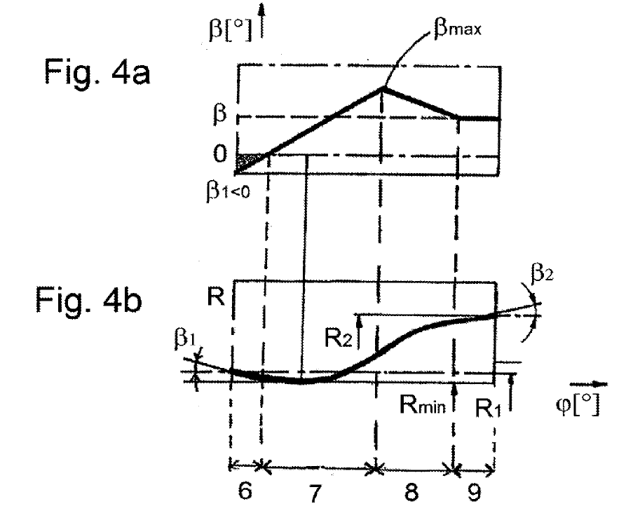

In FIG. 4a, the path of the blade angle β is illustrated.

FIG. 4b shows a conformal mapping of the median line. On the abscissa, the angle of wrap φ is indicated. On the ordinate, the blade angle β of the median lines is indicated.

The blade intake angle β₁ is less than 0°. In a first portion 6, the blade angle β constantly increases until it reaches a value of 0°. In a second portion 7, there is produced a constant drive until the blade angle β reaches a maximum value. The gradient of the increase of the blade angle β is the same in the first portion 6 and in the second portion 7. The blade angle β reaches its maximum value at the turning point of the median line. In a third region 8, the blade angle β constantly decreases until it reaches the value of the blade angle β₂. In a fourth portion 9, the blade angle β remains constant at the value of the blade discharge angle β₂.

The conformal mapping of the median line shows that, starting from the blade radius R₁, the radius first decreases to a minimum value Rₘᵢₙ and subsequently further increases up to the value of the blade discharge radius R₂.

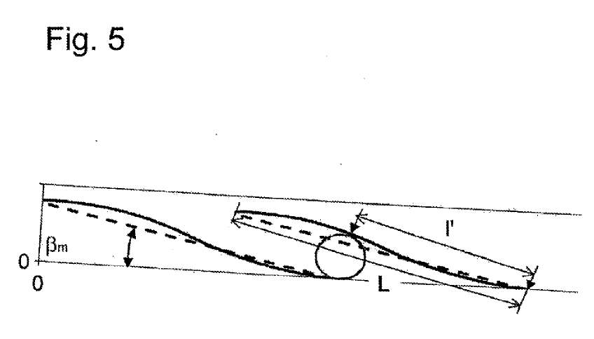

FIG. 5 shows a variable range for a thickness variation. As far as a narrowest portion, a region 1′ which rises with a decreasing number of blades in which the loading (circulation) can be configured in a variable manner is available. This variable range is indicated as 1′ in FIG. 5. In addition, the angle of staggering βₘ is indicated.

According to the invention, the load variation is carried out with additional profiles which in each blade calculation step in terms of length and thickness are varied separately at the intake and pressure side in order to limit the loading (circulation) to the respective minimum magnitude and consequently to prevent separation or cavitation regions (at the intake side) and dead water or return flow regions (at the pressure side).

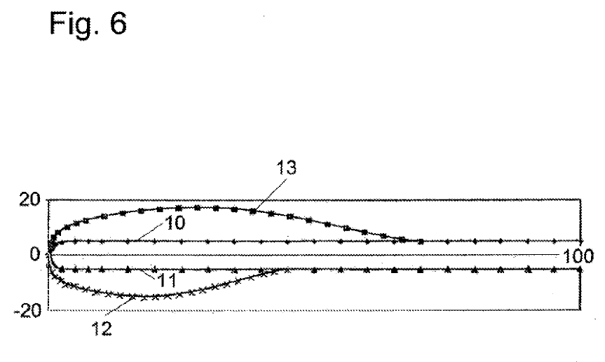

FIG. 6 shows a profile structure with conformal mapping prior to superimposition with the median line having a basic profile 10 of the pressure side and a basic profile 11 of the intake side. From the median line and a symmetrical basic profile (identical profile with elliptical profile projection) as well as an additional profile 12 at the intake side and an additional profile 13 at the pressure side, the desired profile is formed.

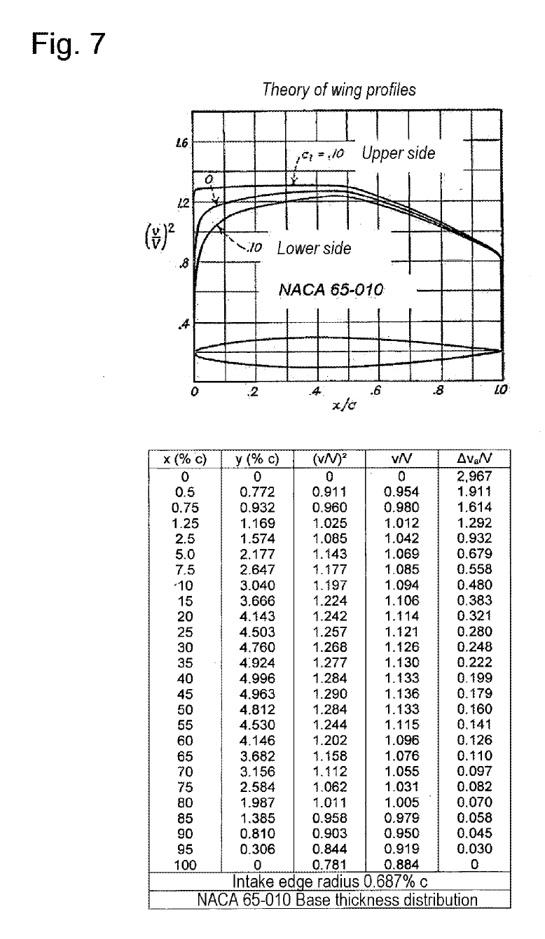

The additional profiles 12, 13 can be provided on the basis of catalogue profiles, for example, a superimposition profile illustrated in FIG. 7 (NACA 65010). The superimposition is carried out in a planar mapping system in accordance with the Kaplan method.

The description of the additional droplets is carried out via maximum thickness and relative length

$$X = \frac{{l}^{′}}{L}$$

separately for the pressure side and intake side

$$Y = \frac{( \frac{D}{{D}_{k}} )}{( \frac{D}{{L}_{k}} )} \cdot {l}^{′}$$

$$X = x \cdot {l}^{′} .$$

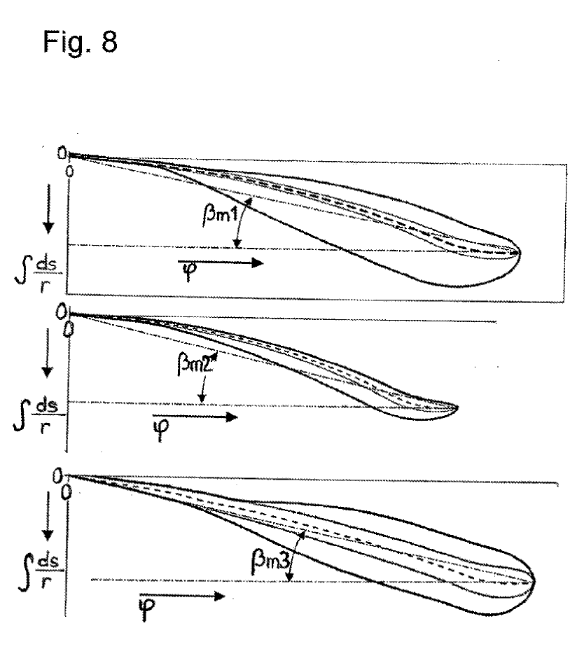

FIG. 8 shows a variable droplet on three flow lines with the conformal mapping. Three blade sections were shown in the conformal mapping forms

$$Y = \int \frac{ds}{r}$$

$$and$$

$$x = ϕ$$

which are conventional with radial pumps.

The optimization of the blade is carried out by adapted configuration and re-calculation methods.

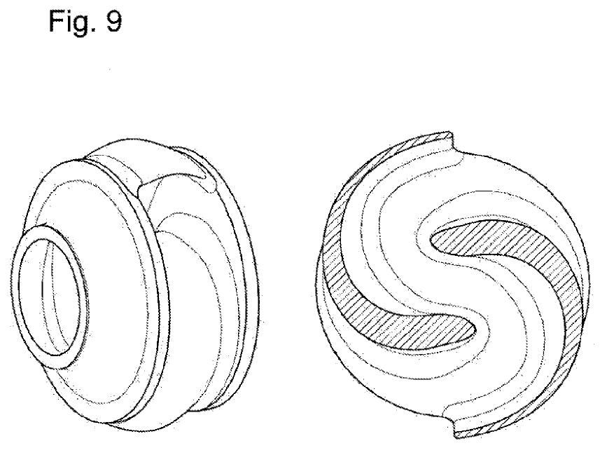

The result of the design is illustrated in FIG. 9 with reference to a dual blade waste water frame. The method can be used for open or closed impellers.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Centrifugal Pump Blade Profile

The invention relates to a centrifugal pump having an impeller which has at least one blade and a method for configuring the profile of a blade of the impeller of a centrifugal pump.

Preferably, the invention relates to centrifugal pumps which are used to convey media containing solids. In this instance, channel type impellers, free-flow impellers or single blade impellers can be used as impellers. Ducted wheels are open or closed impellers with a reduced number of blades. 1, 2 or three blades in radial and semi-axial impellers have been found to be advantageous. The fields of application thereof are liquids which are silted up or loaded with solid materials.

An important parameter for characterizing the usability of such pumps for conveying solid admixtures is the ball passage. The ball passage is also referred to as a free, unnarrowed impeller passage and describes the largest permissible diameter of the solid materials in order to ensure a blockage-free passage.

DE 40 15 331 A1 describes an impeller with only one blade. The single blade impeller produced using a casting method forms between a front cover plate and a rear cover plate a channel whose cross-section decreases from the intake of the single blade impeller toward the discharge. The intake side forms on the first 180° of the rotation angle a semi-circle which is arranged concentrically with respect to the rotation axis. The single blade impeller is constructed in such a manner that an occurrence of cavitations is reduced.

In contrast to single blade impellers, impellers with a plurality of blades are distinguished by a higher degree of efficiency. However, specific requirements are also placed on such impellers in terms of preventing deposits of solid components in the conveying channel. In impellers having multiple blades, specific measures have to be taken to prevent blockages.

DE 88 00 074 U1 describes a pump impeller for a centrifugal pump whose blade intake angle is between 0° and 40°. The impeller blades are constructed in this instance in such a manner that the occurrence of cavitations is reduced and nonetheless a good capacity for suction is ensured in the overload region. To this end, the flow lines of the impeller blades have a portion in which the blade angle increases up to 25°.

In waste water technology, centrifugal pumps with high specific speeds are increasingly used. With conventional impellers, this results, in the event of a blade being subjected to flow, in the stagnation point thereof, in particular during partial load operation, moving to the pressure side of the blades. The intake edges of the blades are flowed around from the pressure side to the intake side. The stagnation point located at the pressure side presses fibers located in the waste water onto the surface of the blades.

When the intake edges of the blades are flowed around, there is a region of high speed. In impellers whose intake edge has a smaller radius of curvature, the speeds are particularly high in this region. If, as a result of the high flow speed, the static pressure falls below the vapor pressure, vapor bubbles which lead to cavitation damage are formed.

The high speed region is adjoined by a region of low speed. Dead water is produced at that location. Fibers which adhere to the intake edge tend to fill this dead water region. As a result of the flow, the fibers are pressed onto the blade contour, wherein the occupation with fibers can increase considerably.

DE 10 2011 007 907 B3 relates to an impeller of a centrifugal pump for conveying media containing solid material. The impeller has at least two blades. The blade intake angle is in this instance less than 0°. The blade angle increases in a first portion until it reaches a value of 0°. In a second portion, there is a further increase until a maximum value is reached. In a third portion, the blade angle decreases again.

The ball passage, the steepness of the characteristic line, the cavitation properties and the blade loading have a particular relationship in waste water impellers. In contrast to applications for clean water, the ball passage is of central importance.

In addition, in impellers, cavitation freedom up to a practically provided NPSH value and smooth running of the wheels is also required. Both conditions can be complied with by means of a small blade loading (conveying height/blade surface) under the peripheral condition of a hydraulically impact-free design.

In applications for high speeds, steep characteristic lines are desired. This characteristic line shape is achieved with low blade numbers (1 or 2). In addition, the blades are intended to have a large wrap-around.

The characteristic line shape is determined by the staggering angle of the blades. The angles at the intake and discharge substantially determine the adaptation of the design to the desired operating location or change the load distribution (pressure difference between blade intake to blade pressure side) along the blade contour.

If small staggering angles or small, partially negative intake angles are combined with very small discharge angles, the loading of the blades as far as the most narrow cross-section which determines the ball passage is increased to a great extent. The larger the ball passage is, the smaller the staggering angle. The smaller the discharge angle is, the higher the loading up to the narrowest cross-section. The increased loading leads to increased NPSH values and in the most unfavorable case to flow separation and consequently to a loss of efficiency.

Consideration is given here to an impeller in which for the conveying of solid material large ball passages in combination with a steep characteristic line are required. The resulting small staggering angles combined with partially negative intake angles and very small intake angles produce an extreme loading of the blades as far as the narrowest cross-section which determines the ball passage. This loading leads to separation in the intake and return flow at the pressure side.

As a result, the object of the invention is to provide a centrifugal pump having an impeller in which the loading of the blades is minimized. In this instance, separation or cavitation regions are intended to be prevented. The formation of dead water regions or return flow regions is also intended to be prevented.

This object is achieved according to the invention by a centrifugal pump having the features of claim 1 and a method for configuring the profile of a blade of the impeller of a centrifugal pump according to claim 11. Preferred variants are set out in the dependent claims.

According to the invention, the blade has a profile which is produced by means of superimposing a symmetrical profile with at least one additional profile and a median line whose blade intake angle is less than 0°. Such a profile ensures uniform loading of the entire blade face. The loading or circulation in this instance is limited to the respective minimum magnitude. Separation or cavitation regions at the intake side are thereby prevented. At the pressure side, as a result of the profile according to the invention, dead water or return flow regions can be prevented in a selective manner.

The term median line (also profile center line or camber line or curvature line) is used to refer to the connection line of the circle center points which are inscribed in a profile. From the projection circle center point to the profile projection, the median line extends in a straight manner. The path of the median line substantially also determines the flow properties. Important geometric characteristic values of the median lines are, in addition to the blade angle, the angle of wrap.

The median line which is used for superimposition in this instance preferably has an angle path in which the negative blade intake angle initially increases until it reaches a value of 0. In a second portion, the blade angle then increases to a maximum value and finally decreases again in a third portion. In a preferred embodiment of the invention, the blade angle of the median line remains constant in an adjacent fourth portion.

As far as the narrowest cross-section, there is available a region which rises with a decreasing number of blades and in which the loading (circulation) can be configured in a variable manner. According to the invention, this load variation is carried out with additional profiles. According to the invention, the profiles are varied in each blade calculation step with regard to length and thickness separately at the intake and pressure side in order to reduce the loading and consequently to prevent at the intake side cavitation or separation and at the pressure side dead water or return flow.

In this instance, the desired profile is formed from a characteristic median line, a symmetrical basic profile and additional profiles at the intake side and additional profiles at the pressure side.

The symmetrical basic profile is preferably a profile of equal thickness with an elliptical profile projection.

The additional profiles can be provided on the basis of catalogue profiles. For example, NACA profiles (National Advisory Committee for Aeronautics) can for this purpose.

The superimposition is carried out in this instance in a planar mapping system of the Kaplan method.

The profile shapes according to the invention are produced by the superimposition of the characteristic median line which has a negative blade intake angle, together with a thickness distribution or a profile droplet. The completed profile is then positioned at the necessary angle of attack βₘ in a conformal mapping.

The entire blade is produced by means of conformal mapping of the individual blade portions which are present in the plane in the flood faces which are present as axially symmetrical rotation faces. Preferably, 1 to 3 flood faces, but a maximum of 7, are involved in this case.

By comparing the parameters which describe the droplets via the flow line radii, a sufficiently smooth surface is produced. The provision of the blade profile is preferably carried out by means of superimposing an asymmetrical profile droplet and the characteristic median line.

Other advantages and features of the invention will emerge from the description of embodiments with reference to drawings and from the drawings themselves.

In the drawings:

FIG. 1 is an axial section through an impeller,

FIG. 2 are plan views of variable droplets on three flow lines,

FIG. 3 is a meridional section,

FIG. 4a shows a path of the blade angle,

FIG. 4b is a conformal mapping of the median line,

FIG. 5 shows a variable region for a thickness variation,

FIG. 6 shows a profile structure in conformal mapping prior to superimposition with the median line,

FIG. 7 shows a superimposition profile using the example of an NACA profile,

FIG. 8 is a conformal mapping of variable droplets on three flow lines,

FIG. 9 is a perspective illustration of an impeller according to the invention.

FIG. 1 is an axial section through a radial impeller. The liquid which is charged with solid admixtures enters the intake mouth 1 of the impeller. The blades 4 which are arranged between the covering plate 2 and carrier plate 3 accelerate the liquid. The liquid flows radially outward from the rotation axis 5.

The impeller is in particular operated at specific speeds of more than 70 l/min. In this instance, a low ratio of blade discharge radius R₂ to blade intake radius R₁ is found to be particularly favorable. In the embodiment, the ratio of blade discharge radius R₂ to blade intake radius R₁ is less than 1.3.

FIGS. 2a, 2b and 2c show variable droplets on three flow lines as a plan view. FIG. 3 shows the three flow lines as a meridional section. By comparing the parameters which describe the droplets over the flow line radius R, there is produced a sufficiently smooth surface. The additional profile droplets are highlighted. The basic profile is left.

In FIG. 4a, the path of the blade angle β is illustrated.

FIG. 4b shows a conformal mapping of the median line. On the abscissa, the angle of wrap φ is indicated. On the ordinate, the blade angle β of the median lines is indicated.

The blade intake angle β₁ is less than 0°. In a first portion 6, the blade angle β constantly increases until it reaches a value of 0°. In a second portion 7, there is produced a constant drive until the blade angle β reaches a maximum value. The gradient of the increase of the blade angle β is the same in the first portion 6 and in the second portion 7. The blade angle β reaches its maximum value at the turning point of the median line. In a third region 8, the blade angle β constantly decreases until it reaches the value of the blade angle β₂. In a fourth portion 9, the blade angle β remains constant at the value of the blade discharge angle β₂.

The conformal mapping of the median line shows that, starting from the blade radius R₁, the radius first decreases to a minimum value Rₘᵢₙ and subsequently further increases up to the value of the blade discharge radius R₂.

FIG. 5 shows a variable range for a thickness variation. As far as a narrowest portion, a region 1′ which rises with a decreasing number of blades in which the loading (circulation) can be configured in a variable manner is available. This variable range is indicated as 1′ in FIG. 5. In addition, the angle of staggering βₘ is indicated.

According to the invention, the load variation is carried out with additional profiles which in each blade calculation step in terms of length and thickness are varied separately at the intake and pressure side in order to limit the loading (circulation) to the respective minimum magnitude and consequently to prevent separation or cavitation regions (at the intake side) and dead water or return flow regions (at the pressure side).

FIG. 6 shows a profile structure with conformal mapping prior to superimposition with the median line having a basic profile 10 of the pressure side and a basic profile 11 of the intake side. From the median line and a symmetrical basic profile (identical profile with elliptical profile projection) as well as an additional profile 12 at the intake side and an additional profile 13 at the pressure side, the desired profile is formed.

The additional profiles 12, 13 can be provided on the basis of catalogue profiles, for example, a superimposition profile illustrated in FIG. 7 (NACA 65010). The superimposition is carried out in a planar mapping system in accordance with the Kaplan method.

The description of the additional droplets is carried out via maximum thickness and relative length

$$X = \frac{{l}^{′}}{L}$$

separately for the pressure side and intake side

$$Y = \frac{( \frac{D}{{D}_{k}} )}{( \frac{D}{{L}_{k}} )} \cdot {l}^{′}$$

$$X = x \cdot {l}^{′} .$$

FIG. 8 shows a variable droplet on three flow lines with the conformal mapping. Three blade sections were shown in the conformal mapping forms

$$Y = \int \frac{ds}{r}$$

$$and$$

$$x = ϕ$$

which are conventional with radial pumps.

The optimization of the blade is carried out by means of adapted configuration and re-calculation methods.

The result of the design is illustrated in FIG. 9 with reference to a dual blade waste water frame. The method can be used for open or closed impellers.

1-20. (canceled)

21. A centrifugal pump, comprising:
an impeller which has at least one blade,
wherein the blade is configured with a profile resulting from superimposition of a symmetrical profile with at least one additional profile and a median line having a blade intake angle is less than 0°.

22. The centrifugal pump as claimed in claim 21, wherein the blade angle β increases in a first portion in a direction from a blade intake end toward a blade outlet end until the blade angle β reaches a value of 0°, then increases in a second portion up to a maximum value and decreases in a third portion.

23. The centrifugal pump as claimed in claim 22, wherein the superimposition is in a planar mapping system in accordance with the Kaplan method.

24. The centrifugal pump as claimed in claim 23, wherein the symmetrical basic profile is a profile of equal thickness with an elliptical profile projection.

25. The centrifugal pump as claimed in claim 24, wherein the basic profile is a NACA profile.

26. The centrifugal pump as claimed in claim 25, wherein the superimposition is with at least one of additional profiles at an intake side and with additional profiles at a pressure side.

27. The centrifugal pump as claimed in claim 26, wherein a description of additional droplets is carried out via at least one of a maximum thickness and a relative length separately for at least one of the pressure side and the intake side.

28. The centrifugal pump as claimed in claim 27, wherein the profile is produced by means of superimposition of an asymmetrical profile droplet with the median line.

29. The centrifugal pump as claimed in claim 28, wherein the profile is positioned at an angle of attack (βm) in a conformal mapping.

30. The centrifugal pump as claimed in claim 29, wherein the blade is produced by a conformal mapping of the blade portions which are present in a plane in the flood faces present as axially symmetrical rotation faces.

31. A method for configuring a profile of a blade of the impeller of a centrifugal pump, in particular a centrifugal pump having an impeller which has at least one blade configured with a profile resulting from superimposition of a symmetrical profile with at least one additional profile and a median line having a blade intake angle is less than 0°, comprising the steps of:
selecting a symmetrical profile;
selecting an additional profile;
selecting a median line whose blade intake angle is less than 0°; and
defining the blade profile by superimposing the symmetrical profile, the additional profile, and the median line.

32. The method as claimed in claim 31, wherein the blade angle β increases in a first portion in a direction from a blade intake end toward a blade outlet end until it reaches a value of 0°, then increases in a second portion up to a maximum value and decreases in a third portion.

33. The method as claimed in claim 32, wherein the superimposition is in a planar mapping system in accordance with the Kaplan method.

34. The method as claimed in claim 33, wherein the symmetrical basic profile is a uniform thickness profile with an elliptical profile projection.

35. The method as claimed in claim 34, wherein the additional profile is a NACA profile.

36. The method as claimed in claim 35, wherein the superimposition is with additional profiles at an intake side and with additional profiles at a pressure side.

37. The method as claimed in claim 36, wherein a description of additional droplets is carried out via at least one of a maximum thickness and relative length separately for at least one of a pressure side and intake side.

38. The method as claimed in claim 37, wherein the profile is produced by superimposition of an asymmetrical profile droplet with the median line.

39. The method as claimed in claim 38, wherein the profile is positioned at an angle of attack (βm) in a conformal mapping.

40. The method as claimed in claim 39, wherein the blade is produced by a conformal mapping of the blade portions which are present in a plane in the flood faces present as axially symmetrical rotation faces.
